(19) United States
(12) Patent Application Publication
(10) Pub. No.: US 2005/0127610 A1
(43) Pub. Date: Jun. 16, 2005

(54) Reduced-wear sealing element

(76) Inventors: Simone Pratesi, Florence (IT); Farshad Ghasripoor, Scotia, NY (US); Mahmut Aksit, Erenkoy-Istanbul (TR); Franco Graziani, Florence (IT)

Correspondence Address: NIXON & VANDERHYE, PC, 1100 N GLEBE ROAD, 8TH FLOOR, ARLINGTON, VA, 22201-4714, US

(21) Appl. No.: 10/500,309

(22) PCT Filed: Dec. 27, 2002
(86) PCT No.: PCT/EP02/14893

(30) Foreign Application Priority Data
Dec. 28, 2001 (IT) M12001A002826

(51) Int. Cl. F16J 15/34

(52) U.S. Cl. 277/404

(57) ABSTRACT

A reduced-wear sealing element, in particular for cylinders and pistons for reciprocating compressors, made at least in part from a self-lubricating plastics material; such a material comprises a wear-resistant polymer matrix, in which are dispersed microcapsules containing a lubricating agent.

The present invention relates to a reduced-wear sealing element, in particular for cylinders and pistons for reciprocating compressors.

More specifically, the invention relates to a plastics material with self-lubricating action which is particularly suitable for the production of such sealing elements.

As is known, reciprocating compressors are equipped with a piston which is moved axially within a cylinder in order to compress a gas.

In general, the piston of reciprocating compressors is provided with one or more annular elements having a sealing and guide function, which are also known as piston rings, arranged coaxially relative to the axis of the piston and the cylinder in a seat formed in the side wall of the piston itself.

In other cases, such elements, which may simultaneously perform both sealing and guide functions, may be accommodated on the stationary part of the cylinder: in this case, it is the surface of the piston which acts as the sliding surface.

There are also elements with a sealing function positioned on the piston shaft, which are accommodated in slots integral with the cylinder body and act on their internal diameter, where they interact with the shaft surface, which functions as a sliding surface.

In the present patent application, the term “sealing element” is taken to mean any of the above-described elements with a sealing and/or guide function.

It is also known that such elements are subject to wear as they slide along the cylindrical cavity.

With the aim of limiting this wear, efforts are made to minimise friction between the sliding surfaces by making use of lubricants in liquid or powder form.

Despite the sliding which generally occurs in the presence of lubricants, wear impairs the integrity of the sealing element over time, such that, after an initial period of service, the compressor is no longer capable of achieving the highest pressures.

This disadvantage is a particularly serious problem for compressors with dry-lubricated cylinders (i.e. without force-feed lubrication) and/or with an elevated operating pressure in which the sealing ring is required to maintain, when in motion, an elevated pressure differential.

In order to minimise wear between components which are in contact during sliding, use has been made of new wear-resistant materials in the manufacture of the sealing element.

Among non-metallic materials, one typical material currently used for sealing element production is tetrafluoroethylene or plastics blends which contain it. Said resin, which is abbreviated as PTFE, is widely used due to its low modulus of elasticity, ease of handling, sealing properties and low coefficient of dynamic friction.

It has, however, been found that a sealing element made from PTFE resin, especially sealing rings for reciprocating pistons, has a tendency to undergo permanent deformation if subjected to stress for extended periods. In particular, under operating conditions of elevated pressure and temperature, PTFE sealing rings not only degrade prematurely, but are also subject to permanent deformation along the dividing line to an extent such as to impair their sealing properties. Moreover, since the temperature of the sliding surfaces in inadequately lubricated reciprocating compressors may rise to values in excess of 100° C., said PTFE sealing elements are often subject to extrusion when subjected to elevated pressure loads. Especially when the coupling members which, during sliding, must come into contact with the sealing elements are made from steel with low thermal conductivity, the temperature of the sliding surfaces tends to rise excessively due to the build-up of heat in the steel, even if the lubricant transmits heat adequately to the coupling member.

When coupling members are made from aluminium alloy equipped with an anticorrosion or wear-resistant lining, less heat is transmitted. Under these conditions, structural damage may occur, not only to the cylinder lining but even to the aluminium substrate.

Under certain service conditions, using PTFE in the production of sealing elements may thus prove somewhat unsatisfactory since it requires reinforcement with other fibres, additives and fillers, the addition of which is, however, also not without disadvantages.

At present, in addition to PTFE, other non-metal-based materials with a low coefficient of friction, such as PEEK and PBS resins, are thus used to produce sealing elements.

In particular, PEEK is a highly wear-resistant material, even in applications with elevated operating loads and elevated pressures.

However, it has been found that using PEEK as the sole constituent of the sealing elements in reciprocating compressors may result in excessive wear of the cylinder liner sleeves.

This disadvantage has been partially overcome by means of the addition of appropriate lubricating fillers between the sliding surfaces.

PBS is currently used as an alternative in the production of sealing elements since said polymer is relatively resistant to elevated temperatures and is capable of forming sulfides with a lubricating action. These properties make it particularly suitable for dry sliding applications.

PBS does, however, exhibit the disadvantage of not having elevated thermal conductivity, which restricts the use thereof under operating conditions with elevated temperatures.

In order to overcome this disadvantage and to increase mechanical strength, PBS is used in combination with additives and fillers which allow the dissipation of excess heat.

It has in fact been found that, in reciprocating compressors with dry-lubricated cylinders, polymer-based sealing elements essentially operate due to the transfer layer present on the metal surface of the cylinder liner sleeve. This phenomenon results in low friction polymer-polymer sliding. When said transfer layer is absent, high friction metal-polymer contact occurs, resulting in premature wear of the sealing ring.

Thus, in the absence of force-feed lubrication, the performance of conventionally used sealing elements is substantially determined by the presence or otherwise of said transfer layer.

It is thus obvious that it would be worthwhile to be able to make use of sealing elements made from materials with a low wear rate which are capable of continuously forming a transfer film which reduces the friction force between the sliding parts.

The object of the present invention is accordingly to overcome the above-mentioned disadvantages and in particular to provide a reduced-wear sealing element, in particular for cylinders and pistons for reciprocating compressors, which makes it possible to eliminate or substantially to reduce the disadvantages of the prior art relating to premature wear, with consequent low reliability.

Another object of the present invention is to provide a non-metal-based material for the production of a reduced-wear sealing element, in particular for cylinders and pistons for reciprocating compressors, which has a low wear rate and does not require force-feed lubrication, so being of great utility in dry-lubricated cylinder applications.

A further object of the invention is to provide a self-lubricating plastics material for a reduced-wear sealing element, in particular for cylinders and pistons for reciprocating compressors, which material has good wear resistance properties, even under conditions with elevated pressure loads and elevated temperatures.

Another object is to provide a plastics material for the production of a reduced-wear sealing element, in particular for cylinders and pistons for reciprocating compressors, which is substantially not subject to permanent deformation under sliding conditions without lubricant.

Said and other objects according to the invention are achieved by producing a reduced-wear sealing element, in particular for cylinders and pistons for reciprocating compressors, as set out in claim 1.

In particular, a first aspect of the present invention provides a reduced-wear sealing element, in particular for cylinders and pistons for reciprocating compressors, produced with a self-lubricating material comprising a wear-resistant polymer matrix in which are dispersed microcapsules containing a lubricating agent.

Further features are provided in the subsequent claims. Advantageously, the polymer matrix of the sealing element according to the present invention comprises one or more thermoplastic and/or thermosetting resins exhibiting a low wear rate even under elevated pressure and temperature conditions.

According to a preferred embodiment of the invention, such a polymer matrix comprises one or more polyketones, advantageously aromatic polyketones, it being preferred, among said polyketones, to use polyetherether ketone (PEEK).

According to another embodiment, base components of such a polymer matrix which may be used are thermoplastic or thermosetting resins having elevated wear resistance under operating conditions with elevated loads, such as, for example, polytetrafluoroethylene (PTFE) and polybutadiene-styrene (PBS), individually, together with one another or blended with other polymers.

The polymer matrix of the sealing element of the invention may also contain further substances capable of imparting greater resistance to frictional wear.

For example, the polymer matrix may comprise additives and/or fillers which assume the function of increasing the thermal conductivity of the material of the invention in order efficiently to dissipate the heat generated by any friction between the sliding parts.

The material of the sealing element of the invention may advantageously also contain fibres with elevated mechanical strength and elevated resistance to deformation and wear.

According to one embodiment, the polymer matrix furthermore provides the incorporation of a hard phase and/or a transfer film in order to reduce friction between the sliding partners.

An essential feature of the material of the sealing element of the invention is the presence of lubricating microcapsules dispersed with the polymer matrix.

For the purposes of the present invention, lubricating microcapsules are intended to mean encapsulated lubricating particles and multiparticles, homogeneous fluids or encapsulated lubricating multilayer materials and in general lubricating agents incorporated in microcapsules.

Suitable lubricating agents are lubricating oils, such as for example organic, natural or synthetic oils.

Particularly suitable oils are lubricating oils which are low in acidity and resistant to elevated operating temperatures.

According to a preferred embodiment, the lubricating oil incorporated into said microcapsules exhibits viscosity values within the range between 20 and 250 cSt, measured at a temperature of approx. 40° C.

The microcapsules used for the purposes of the present invention may be spherical, symmetrical or irregularly shaped.

According to one embodiment, the capsules have an average diameter within the range between 5 and 500 microns.

Advantageously, said microcapsules comprise a shell of wax or of a polymer material, preferably polyoxymethylene urea, which is abbreviated as PMU.

Apart from the lubricating agent, the microcapsules may contain selected additives depending upon the intended application. In particular for use under elevated pressure conditions, microelements such as zinc, boron and mixtures thereof may be incorporated.

Advantageously, the lubricating microcapsules are uniformly dispersed within the polymer matrix in such a manner as to achieve contents by weight of between 2 and 30 wt. %.

The capsules containing the lubricating fluid may be produced using various microencapsulation technologies, such as dry spraying, prilling, coacervation, with soft alginate beads and in situ polymerisation.

The various lubricant encapsulation technologies are used depending upon the required dimensions of the lubricating particles and upon the ultimate use of the plastics material of the invention.

Using the dry spraying process, for example, it is possible to encapsulate the oils in capsules of dimensions as small as 5-30 microns.

In the prilling process, which is usually used to produce capsules of dimensions between 1 and 100, the lubricant to be encapsulated is first of all introduced into a molten wax or other polymer matrix, then sprayed into droplets and cooled to solidify them. The resultant microcapsules act as a shell for the lubricant contents. Microcapsules produced by prilling release the lubricant under pressure or, if desired, by selecting polymers with an appropriate melting point, after exposure to a predetermined temperature.

Using the coacervation method, the lubricant may also be enclosed in capsules of a diameter within the range between 25 and approx. 300 microns.

In simple coacervation, the walls of the capsules are typically made from gelatine, polyvinyl alcohol, methylcellulose, polyvinylpyrrolidone and other polymers.

In complex coacervation, the capsule walls are produced using systems based on gelatine-acacia copolymers.

Among the various technologies which are available, in situ polymerisation is preferred for the production of the microcapsules because it makes it possible to produce a strong polymer shell, preferably of urea-formaldehyde copolymer (PMU), around the drop of lubricating liquid. Encapsulation in a PMU shell is typically an emulsion process, in which an emulsion of the material to be encapsulated is prepared in an aqueous solution.

By way of example, microcapsules containing lubricant produced using the method described in U.S. Pat. No. 5,112,541 may be used for the purposes of the present invention.

Once produced, the microcapsules are incorporated into the polymer matrix, preferably by moulding, for example by means or compression or injection moulding.

Temperatures within the range between 260 and 350° C. are conveniently used during moulding.

Compression moulding is advantageously performed within a closed mould in order to permit uniform heating and pressurisation of the composite material.

According to one embodiment, the mould is pressurised when cold for example to 1.5-2.5 t in order to expel the air from the mould. The mould is placed in a preheated press. The temperature of the press conveniently depends upon the melting point of the polymer material used. Approx. 80-90% of the selected temperature can be achieved before application of the load. The load is thus generally applied to values of between 250 and 1500 kg with time and pressure increments for a total period of approx. 10-15 minutes. The final load is maintained while the mould is allowed to cool to ambient temperature.

According to another embodiment, the injection moulding method is used, with low processing temperatures or short heating and cooling cycles.

It has been found that using the self-lubricating material of the sealing element of the invention minimises the transfer layer required for self-lubrication by providing, due to the microcapsules, a replenishable source of lubricant. Furthermore, its use surprisingly reduces the wear rate of the sealing element, so minimising the risk of surface wear of the sliding partner and increasing the service life of the compressor.

Advantageously, the sealing element of the present invention is the sealing ring piston or cylinder of a reciprocating compressor which makes it possible to reduce friction and/or appreciably to improve service life, in particular for dry sliding applications.

Further features and advantages associated with the reduced-wear sealing element, in particular for reciprocating compressor pistons or cylinders, according to the present invention will emerge more clearly from the following description, which is provided merely by way of non-limiting example, with reference to the attached diagrams, in which:

FIG. 1 is a schematic diagram of the mode of operation of a conventional sealing element for a piston in a reciprocating compressor;

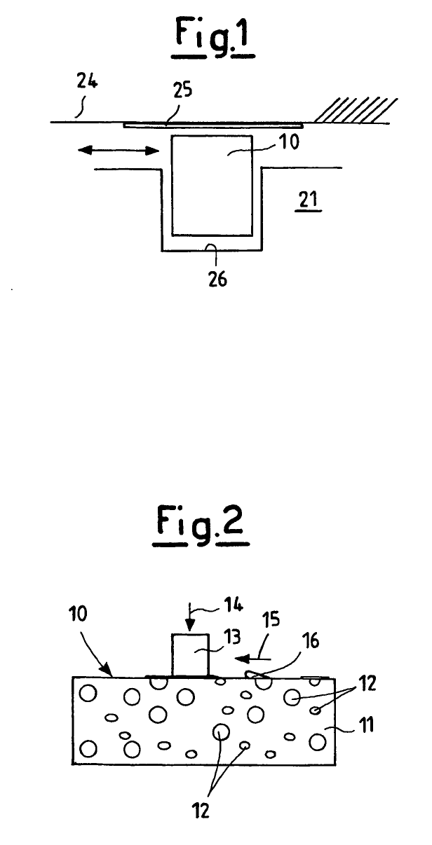

FIG. 2 is a schematic diagram of a side-section of a sealing element of the invention and the sliding partner;

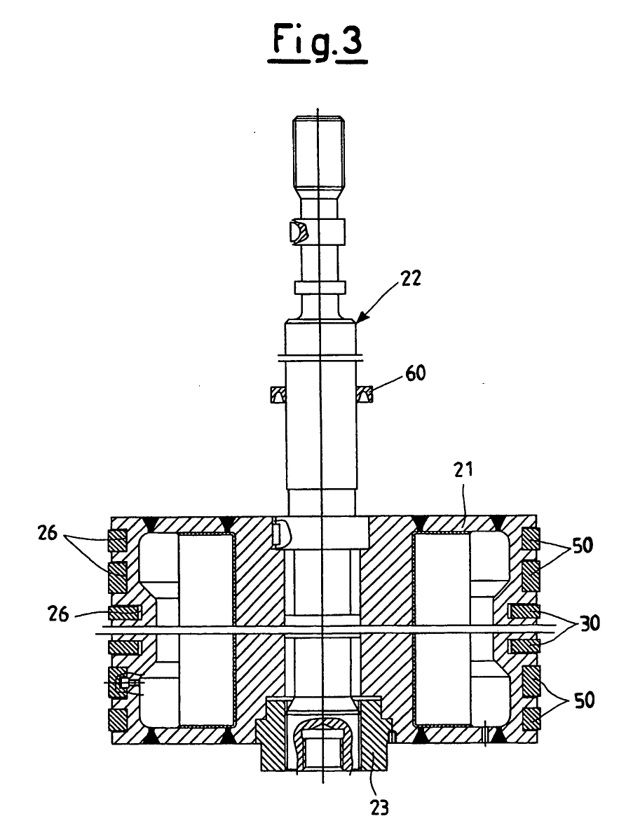

FIG. 3 is a partially sectional side elevation of a piston equipped with sealing elements according to the invention;

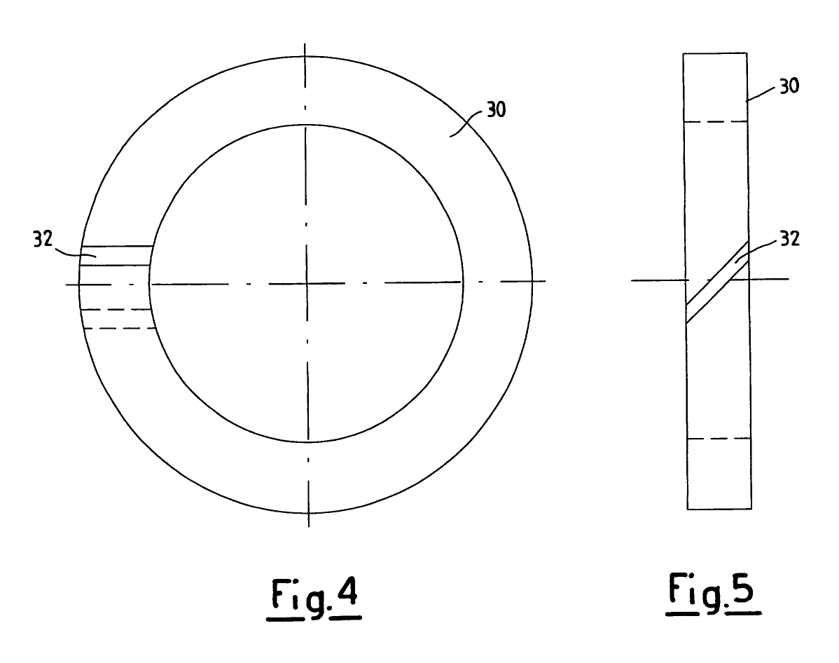

FIG. 4 is plan view from above of a first embodiment of a sealing element according to the invention, which has a sealing function for the piston;

FIG. 5 is a side elevation of the sealing element of FIG. 4;

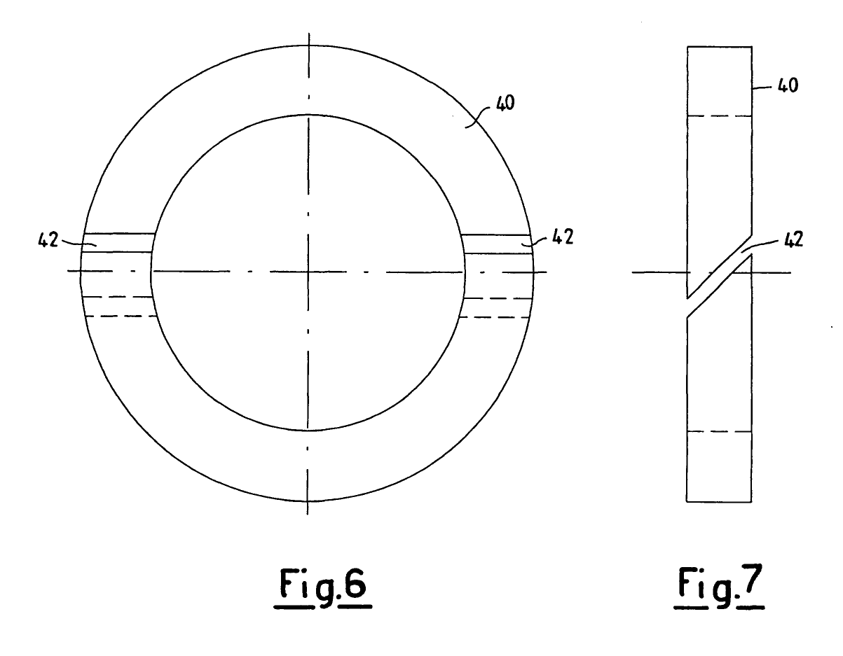

FIG. 6 is plan view from above of a second embodiment of a sealing element according to the invention, which has a sealing function for the piston;

FIG. 7 is a side elevation of the sealing element of FIG. 6;

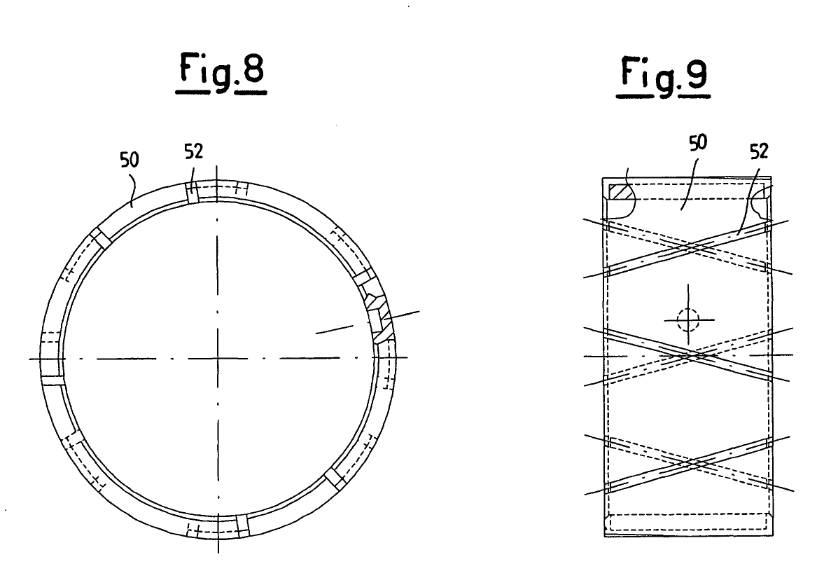

FIG. 8 is plan view from above of a third embodiment of a sealing element according to the invention, which has a guide function for the piston;

FIG. 9 is a side elevation of the sealing element of FIG. 8;

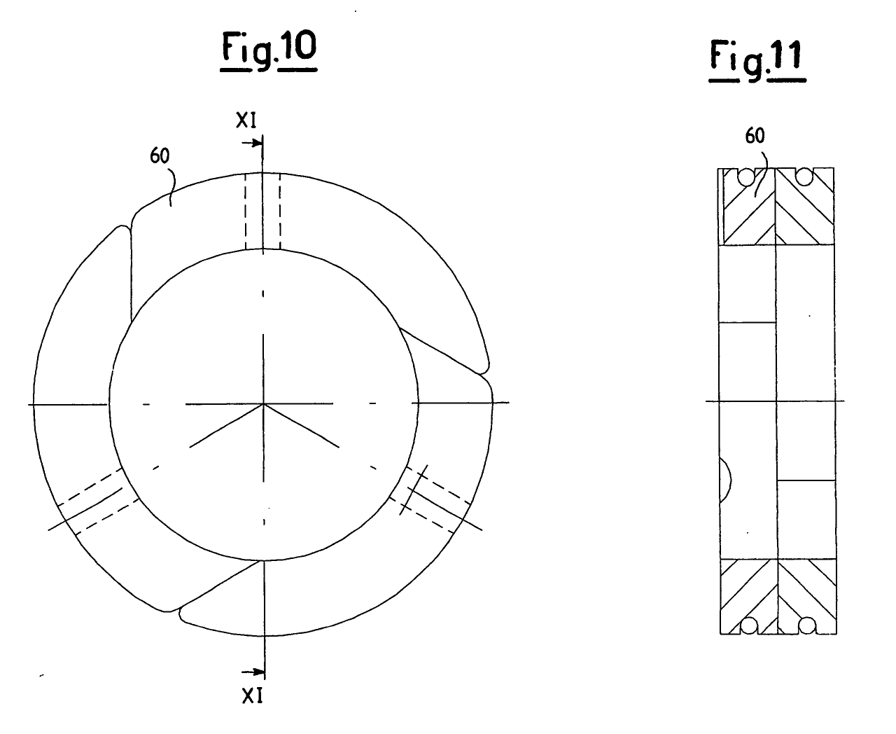

FIG. 10 is plan view from above of a fourth embodiment of a sealing element according to the invention, which has a sealing function for a piston shaft;

FIG. 11 is a sectional side elevation of the sealing element according to FIG. 10 along the section plane XI-XI of FIG. 10.

With reference to FIG. 1, a conventional sealing ring 10 made from PEEK resin is shown accommodated in a lateral seat 26 of a piston 21 of a reciprocating compressor (not shown). The piston 21 moves with a reciprocating motion, sliding along an internal sleeve 24 of a cylinder (not shown). The sliding motion between the two sliding partners takes place due to a sliding layer 25 deposited on the metal surface of the sleeve 24. This layer or film allows a reciprocating motion with a low coefficient of friction. Absence of the sliding layer 25 results in higher friction due to metal-resin contact.

With reference to FIG. 2, reference numeral 10 indicates a cross-section of an embodiment of a sealing element made from self-lubricating material according to the invention.

The sealing element 10 comprises a polymer matrix 11 of PEEK, in which are uniformly dispersed microcapsules 12 filled with lubricating oil. FIG. 2 furthermore schematically illustrates the sliding partner 13 of the sealing element 10, which, under the pressure load indicated with reference numeral 14, slides along the sliding surface in the direction indicated by the arrow identified with the reference numeral 15. The microcapsules 12 filled with fluid lubricant are transformed into ruptured microcapsules 16 by the shear force. The release of fluid from the ruptured microcapsules 16, which may also be effected thermally, lubricates the sliding surfaces, reducing the coefficient of friction and wear.

FIG. 3 shows a piston 21 fastened onto a shaft 22 by means of a nut 23. On the side of the piston 21 and shaft 22 are located sealing elements, such as sealing rings 30 and 40 and guide rings or pads 50, which are located in circumferential seats 26 provided in the side of the piston 21, and packing rings 60, which are located in circumferential seats provided on the outside of the shaft 22.

FIGS. 4 and 5 show a first embodiment of a sealing ring 30 which acts as a sealing element for a seat 26 of FIG. 3; the ring 30 is provided with a through cut 32 inclined relative to the axis of the ring 30.

FIGS. 6 and 7 show a second embodiment of a sealing ring 40 which acts as a sealing element for a seat 26 of FIG. 3; the ring 40 is provided with two through cuts 42, inclined relative to the axis of the ring 40, which divide the ring 40 into two parts.

The purpose of the cuts 32 and 42 is to facilitate fitting of the rings 30 and 40 respectively into the seats 26 of the piston 21 of FIG. 3.

In general, the rings 30 are used for pistons 21 of large dimensions, while the rings 40 are preferred for smaller pistons 21.

FIGS. 8 and 9 show a guide ring or pad 50 which acts as a guide element and support for the piston 21 when in motion; the ring 50 is provided with grooves 52, inclined relative to the axis of the ring 50, the purpose of which is to equalise pressure.

FIGS. 10 and 11 show a packing ring 60 which acts as a sealing element to prevent gas blow-by; the ring 60 slides on the shaft 22 and is accommodated in a circumferential seat on the outside of the shaft 22. Experimental testing has been carried out which demonstrates the improvement achieved by using a reduced-wear sealing element according to the invention. Testing was initially carried out on a sealing element made from a polymer designated Ultem 1000, a conventional product of General Electric, and an identical sealing element made from a polymer material based on Ultem 1000 with microcapsules incorporated at a rate of 10 wt. %.

The microcapsules incorporated into the Ultem 1000 resin contain a low viscosity oil according to one embodiment of the sealing element of invention.

The wear tests were performed under conditions which provide a sliding speed of 300 ft/min (1.524 m/s), a pressure load of 200 psi (13.8 bar) and a test duration of 20 hours “run-in” and 80 hours “steady state”.

On the basis of the results from the tests performed, it is clear that the wear rate against steel of the plastic Ultem 1000 incorporating microcapsules produced according to an embodiment of the method of the invention, is reduced by a good three orders of magnitude, while friction is reduced by one order of magnitude, relative to the prior art resin Ultem 1000. Friction tests against tempered steel were also performed on a PEEK sealing element (Victrex PEEK 450G from GE Corporation) and on a second PEEK sealing element with incorporated microcapsules of Gargoyl lubricant in a quantity equivalent to approx. 10% of the weight thereof according to an embodiment of the invention.

The results show, for the sealing element according to the present invention, a significant reduction in the coefficient of friction of approx. one order of magnitude.

The description provided clearly demonstrates not only the features of a reduced-wear sealing element, in particular for cylinders and pistons for reciprocating compressors, provided by the present invention, but also the advantages associated therewith, which are also revealed by the results of the experimental testing performed and described above.

Finally, it is clear that the reduced-wear sealing element, in particular for cylinders and pistons for reciprocating compressors, as described above may be the subject of many modifications and variants, all of which fall within the invention; moreover, any details may be replaced by technically equivalent elements. In practice, the material used, together with the shapes and dimensions, may be any as defined according to technical requirements.

The scope of protection of the invention is thus delimited by the attached claims.

1. A reduced-wear sealing element, characterised in that it is made at least in part from a self-lubricating plastics material comprising a wear-resistant polymer matrix, in which are dispersed microcapsules containing a lubricating agent.

2. A sealing element according to claim 1, characterised in that said polymer matrix comprises a polyketone.

3. A sealing element according to claim 2, characterised in that said polyketone is an aromatic polyketone.

4. A sealing element according to claim 3, characterised in that said aromatic polyketone is polyetherether ketone (PEEK).

5. A sealing element according to claim 1, characterised in that said polymer matrix comprises a resin selected from among polybutadiene-styrene (PBS), polytetrafluoroethylene (PTFE) and blends thereof.

6. A sealing element according to claim 1, characterised in that said microcapsules comprise a shell of polyoxymethylene urea (PMU).

7. A sealing element according to claim 1, characterised in that said microcapsules have an average diameter of between 5 and 500μ.

8. A sealing element according to claim 1, characterised in that said microcapsules are dispersed in said polymer matrix in a ratio by weight of between 2 and 30 wt. %.

9. A sealing element according to claim 1, characterised in that said lubricant incorporated in the microcapsules is an oil which is low in acidity.

10. A sealing element according to claim 1, characterised in that said lubricant is a fluid lubricant which has a viscosity within the range between 20 and 250 cSt.

11. A sealing element according to claim 1, characterised in that said lubricant further comprises an additive or filler to increase mechanical strength or thermal conductivity.

12. A sealing element according to claim 11, characterised in that said additive is a microelement selected from the group consisting of zinc, boron and mixtures thereof.

13. A sealing element according to claim 1, characterised in that it is a sealing ring for a piston or cylinder of a reciprocating compressor.

14. A sealing element according to claim 1, characterised in that it is a guide ring for a piston or cylinder of a reciprocating compressor.

15. A sealing element according to claim 1, characterised in that it is a packing ring for a shaft of a piston of a reciprocating compressor.

16. A sealing element according to claim 13, characterised in that said sealing ring is accommodated in a circumferential seat provided in the side of a piston of a reciprocating compressor.

17. A sealing element according to claim 14, characterised in that said guide ring has grooves and is accommodated in a circumferential seat provided in the side of a piston of a reciprocating compressor.

18. A sealing element according to claim 16, characterised in that said sealing ring has at least one through cut, inclined relative to the axis of the ring.
